(19) United States
(12) Patent Application Publication
(10) Pub. No.: US 2006/0031834 A1
(43) Pub. Date: Feb. 9, 2006

(54) Optimizing transactions based on a set of persistent objects

(75) Inventors: Mercer Logan Colby, Rochester, MN (US); Stephen Jason Fink, Yorktown Heights, NY (US); Matt Richard Hogstrom, Cary, NC (US)

Correspondence Address: IBM CORPORATION;ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 10/911,850

(22) Filed: Aug. 5, 2004

(51) Int. Cl. G06F 9/46

(52) U.S. Cl. 718/100

(57) ABSTRACT

A method, apparatus, system, and signal-bearing medium that, in an embodiment, identify a component that initiates a transaction in an application, calculate a set of persistent objects potentially enlisted by the transaction, and calculate a set of potential operations that the transaction may perform with respect to each of the potentially enlisted persistent objects. The transaction is then optimized based on a configuration, where the configuration is based on the set of potential operations that the transaction may perform with respect to each of the potentially enlisted persistent objects. If a single invocation of the component initiates more than one transaction, actions taken by the set of persistent objects are collapsed into a collapsed set, and policies relevant to the collapsed set are associated with a unique task name.

### CROSS-REFERENCE TO RELATED APPLICATION

The present application is related to commonly-assigned application Ser. No. 10/674,998, entitled “Method, System, and Storage Medium for Providing Context-Based Dynamic Policy Assignment in a Distributed Processing Environment,” filed Sep. 30, 2003, which is herein incorporated by reference.

### FIELD

An embodiment of the invention generally relates to computers. In particular, an embodiment of the invention generally relates to the scoped units of work in computer software.

### BACKGROUND

The development of the EDVAC computer system of 1948 is often cited as the beginning of the computer era. Since that time, computer systems have evolved into extremely sophisticated devices, and computer systems may be found in many different settings. Computer systems typically include a combination of hardware components (such as semiconductors, integrated circuits, programmable logic devices, programmable gate arrays, power supplies, electronic card assemblies, sheet metal, cables, and connectors) and software, also known as computer programs.

Software developers face the fundamental problem that writing an enterprise-wide application is difficult, and writing a distributed application is even more difficult. In addition, an enterprise seeks to build an application as fast as possible without being locked into one platform. Ideally, enterprise developers would like to be able to write the application once and run it on all of their platforms. Enterprise JavaBeans technology seeks to provide this ability.

The Enterprise JavaBeans (EJB) component architecture is designed to enable enterprises to build scalable, secure, multi-platform, business-critical applications as reusable, server-side components. Its purpose is to solve the enterprise problems by allowing the enterprise developer to focus only on writing business logic. The EJB specification creates an infrastructure that takes care of the system-level programming, such as transactions, security, threading, naming, object-life cycle, resource pooling, remote access, and persistence. EJB also simplifies access to existing applications, and provides a uniform application development model for tool creation use using object-oriented programming techniques.

Object-oriented programming techniques involve the definition, creation, use, and instruction of “objects”. These objects are software entities comprising data elements or attributes and methods, which manipulate data elements. Objects also may include data related to events outside of the object to trigger or control methods within the object.

Java is an object-oriented programming language and environment focusing on defining data as objects and the methods that may be applied to those objects. Java supports only a single inheritance, meaning that each class can inherit from only one other class at any given time. Java also allows for the creation of totally abstract classes known as interfaces, which allow the defining of methods that may be shared with several classes without regard for how other classes are handling the methods.

The Java virtual machine (JVM) is a virtual computer component that resides in memory. In some cases, the JVM may be implemented in a processor. The JVM allows Java programs to be executed on a different platform as opposed to only the one platform for which the code was compiled. Java programs are compiled for the JVM. In this manner, Java is able to support applications for many types of data processing systems, which may contain a variety of central processing units and operating systems architectures.

To enable a Java application to execute on different types of data processing systems, a compiler typically generates an architecture-neutral file format—the compiled code is executable on many processors, given the presence of the Java run-time system. The Java compiler generates bytecode instructions that are non-specific to a particular computer architecture. These bytecodes are executed by a Java interpreter. A Java interpreter is a module in the JVM that alternately decodes and executes a bytecode or bytecodes.

A Java bean is a reusable component. Various programs in Java may be created by aggregating different Java beans. An entity bean represents a business object in a persistent storage mechanism. Some examples of business objects are customers, orders, and products. In the J2EE (Java 2 Platform Enterprise Edition), the storage mechanism is a relational database. Typically, each entity bean has an underlying table in a relational database, and each instance of the bean corresponds to a row in that table.

Entity beans differ from session beans in several ways. Entity beans are persistent, allow shared access, have primary keys, and may participate in relationships with other entity beans. Because the state of an entity bean is saved in a storage mechanism, it is persistent. Persistence means that the entity bean's state exists beyond the lifetime of the application or the J2EE server process. The data in a database is persistent because it still exists even if the database server or the applications it services are powered off.

There are two types of persistence for entity beans: bean-managed and container-managed. With bean-managed persistence, the entity bean code contains the calls that access the database. If a bean has container-managed persistence, the EJB container automatically generates the necessary database access calls. The code for the entity bean does not include these calls.

Entity beans may be shared by multiple clients. Because the clients might want to change the same data, it's important that entity beans work within transactions. Typically, the EJB container provides transaction management. In this case, the bean's deployment descriptor specifies the transaction attributes. Transaction boundaries are not coded in the bean because the container marks the boundaries.

Like a table in a relational database, an entity bean may be related to other entity beans. For example, in a college enrollment application, StudentEJB and CourseEJB would be related because students enroll in classes.

Developers implement relationships differently for entity beans with bean-managed persistence and those with container-managed persistence. With bean-managed persistence, the code implements the relationships. But, with container-managed persistence, the EJB container takes care of the relationships for the developer. For this reason, relationships in entity beans with container-managed persistence are often referred to as container-managed relationships.

The term container-managed persistence means that the EJB container handles all database access required by the entity bean. The bean's code contains no database access calls. As a result, the bean's code is not tied to a specific persistent storage mechanism (database). Because of this flexibility, even if the developer redeploys the same entity bean on different J2EE servers that use different databases, modifying or recompiling the bean's code is not necessary. In short, container-managed persistent entity beans are more portable.

Besides being much easier to develop and offering greater portability, container-managed persistent beans have additional benefits over bean-managed persistent beans, such as query, caching, and connection pooling. Also, container-managed persistent beans enable greater configuration and administration options, allowing dynamic control over access intent and connectivity parameters.

One of the primary points of comparison between the competitive implementations of the J2EE specification is performance, generally measured in the number of transactions that can be executed in a given period of time. Some implementations of J2EE allow performance optimizations to be targeted for a particular unit of work, such as a type of transaction. For example, read-only transactions can be configured to enlist entity beans (object representations in persistent data storage) with low-locking requirements, while other transactions can be configured to grab update locks on the same entity beans. This targeting allows the system to significantly reduce contention between transactions for backend database access. Other organizations can likewise be configured on particular units of work.

Application configuration based on units of work has been proven, in theory, to deliver significant performance improvements when tested-by benchmark programs. But, in practice, some users have found unit-of-work based application configuration to be prohibitively complex and error-prone because large applications may initiate thousands of distinct units of work, each of which use system resources in distinct manners. The effort required to configure such an application can quickly become prohibitive.

To complicate matters, in J2EE, simply identifying units of work (transactions) can be prohibitively complex. The J2EE specification enables the methods of EJBs to be configured with the transaction attribute of “required,” in which case an EJB method call may or may not initiate a new transaction based on the dynamic program state at the call. Unfortunately, an application's deployment descriptor does not carry enough information to derive the boundaries of units of work. Instead, a human must perform manual analysis of the application's code. Even worse, consultants are frequently asked to assist in tuning customer's applications, but are not given access to the source code, which also inhibits manual configuration.

Thus, without a better way to configure applications based on units-of-work, users will continue to experience difficulty improving the performance of their applications. Although the aforementioned problems have been described in the context of J2EE, they may occur in any environment.

### SUMMARY

A method, apparatus, system, and signal-bearing medium are provided that, in an embodiment, identify a component that initiates a transaction in an application, calculate a set of persistent objects potentially enlisted by the transaction, and calculate a set of potential operations that the transaction may perform with respect to each of the potentially enlisted persistent objects. The transaction is then optimized based on a configuration, where the configuration is based on the set of potential operations that the transaction may perform with respect to each of the potentially enlisted persistent objects. If a single invocation of the component initiates more than one transaction, actions taken by the set of persistent objects are collapsed into a collapsed set, and policies relevant to the collapsed set are associated with a unique task name.

### BRIEF DESCRIPTION OF THE DRAWING

FIG. 1 depicts a block diagram of an example system for implementing an embodiment of the invention.

FIG. 2 depicts a block diagram of an example data structure for results, according to an embodiment of the invention.

FIG. 3 depicts a block diagram of an example user interface, according to an embodiment of the invention.

FIG. 4 depicts a flowchart of example processing at an analysis engine and a configuration manager, according to an embodiment of the invention.

FIG. 5 depicts a flowchart of example processing for creating a suggested configuration, according to an embodiment of the invention.

FIG. 6 depicts a block diagram illustrating analysis of an application, according to an embodiment of the invention.

### DETAILED DESCRIPTION

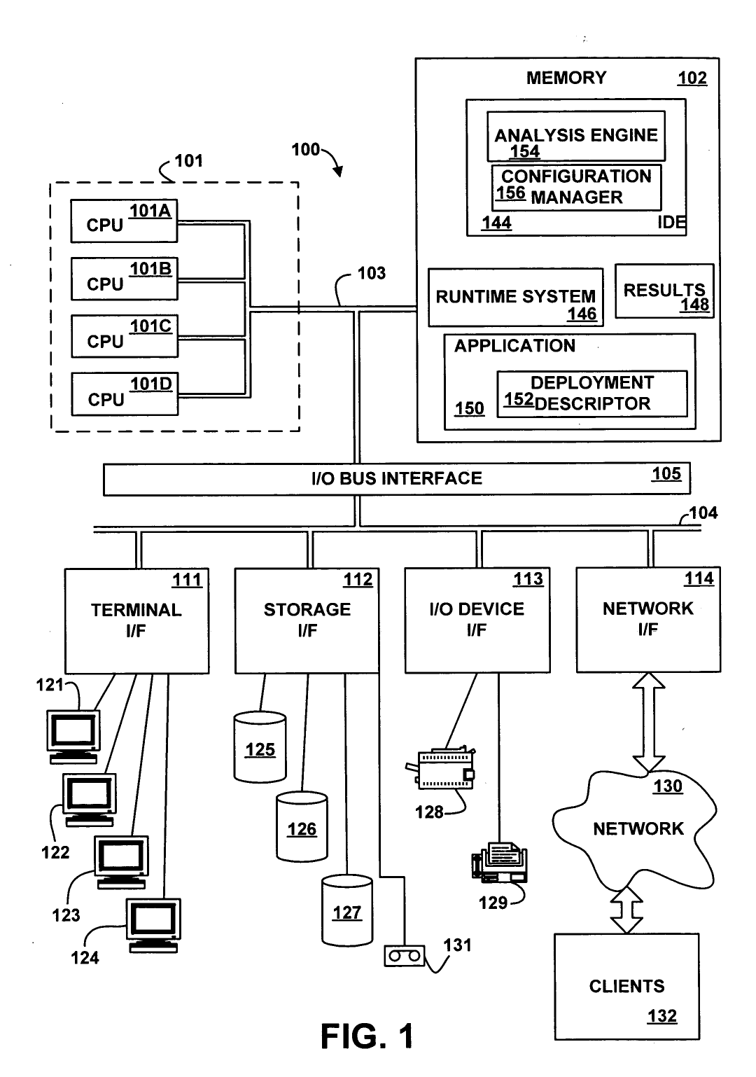

Referring to the Drawing, wherein like numbers denote like parts throughout the several views, FIG. 1 depicts a high-level block diagram representation of a computer system 100 connected to clients 132 via a network 130, according to an embodiment of the present invention. The major components of the computer system 100 include one or more processors 101, main memory 102, a terminal interface 111, a storage interface 112, an I/O (Input/Output) device interface 113, and communications/network interfaces 114, all of which are coupled for inter-component communication via a memory bus 103, an I/O bus 104, and an I/O bus interface unit 105.

The computer system 100 contains one or more general-purpose programmable central processing units (CPUs) 101A, 101B, 101C, and 101D, herein generically referred to as the processor 101. In an embodiment, the computer system 100 contains multiple processors typical of a relatively large system; however, in another embodiment, the computer system 100 may alternatively be a single CPU system. Each processor 101 executes instructions stored in the main memory 102 and may include one or more levels of on-board cache.

The main memory 102 is a random-access semiconductor memory for storing data and programs. The main memory 102 is conceptually a single monolithic entity, but in other embodiments, the main memory 102 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may further be distributed and associated with different CPUs or sets of CPUs, as is known in any of various so-called non-uniform memory access (NUMA) computer architectures.

The memory 102 includes an IDE (Integrated Development Environment) 144, a runtime system 146, results 148, and an application 150. Although the IDE 144, the runtime system 146, the results 148, and the application 150 are illustrated as being contained within the memory 102 in the computer system 100, in other embodiments, some or all of them may be on different computer systems and may be accessed remotely, e.g., via the network 130. The computer system 100 may use virtual addressing mechanisms that allow the programs of the computer system 100 to behave as if they only have access to a large, single storage entity instead of access to multiple, smaller storage entities. Thus, while the IDE 144, the runtime system 146, the results 148, and the application 150 are all illustrated as being contained within the memory 102 in the computer system 100, these elements are not necessarily all completely contained in the same storage device at the same time.

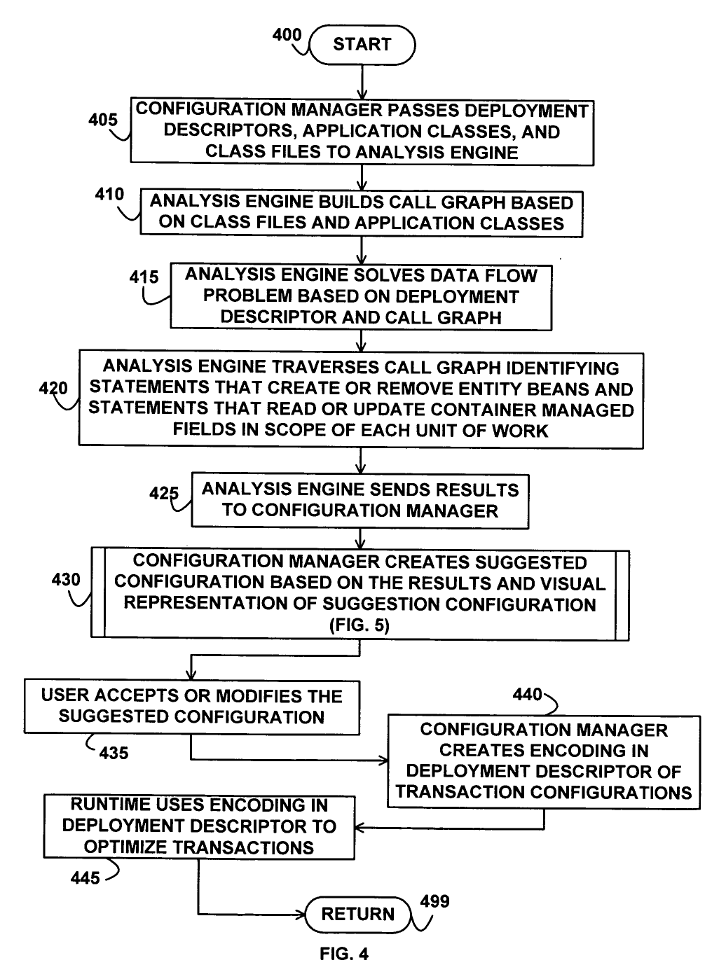

The IDE 144 includes an analysis engine 154 and a configuration manager 156. The application 150 includes a deployment descriptor 152. The analysis engine 154 creates the results 148 based on class files, application classes, and the deployment descriptor 152 and sends the results 148 to the configuration manager 156. The functions of the analysis engine 154 are further described below with reference to FIG. 4.

The configuration manager 156 processes the results 148 of the analysis in order to create a configuration for the application 150 that will result in optimized behavior according to the specific capabilities of the application server on which the analyzed application 150 will execute. The functions of the configuration manager 154 are further described below with reference to FIGS. 4, 5, and 6.

In an embodiment, the analysis engine 154 and/or the configuration manager 156 include instructions capable of executing on the processor 101 or statements capable of being interpreted by instructions executing on the processor 101 to perform the functions as further described below with reference to FIGS. 4, 5, and 6. In another embodiment, the analysis engine 154 and/or the configuration manager 156 may be implemented in microcode. In yet another embodiment, the analysis engine 154 and the configuration manager 156 may be implemented in hardware via logic gates and/or other appropriate hardware techniques, in lieu of or in addition to a processor-based system.

The memory bus 103 provides a data communication path for transferring data among the processors 101, the main memory 102, and the I/O bus interface unit 105. The I/O bus interface unit 105 is further coupled to the system I/O bus 104 for transferring data to and from the various I/O units. The I/O bus interface unit 105 communicates with multiple I/O interface units 111, 112, 113, and 114, which are also known as I/O processors (IOPs) or I/O adapters (IOAs), through the system I/O bus 104. The system I/O bus 104 may be, e.g., an industry standard PCI (Peripheral Component Interconnect) bus, or any other appropriate bus technology. The I/O interface units support communication with a variety of storage and I/O devices. For example, the terminal interface unit 111 supports the attachment of one-or more user terminals 121, 122, 123, and 124.

The storage interface unit 112 supports the attachment of one or more direct access storage devices (DASD) 125, 126, and 127 (which are typically rotating magnetic disk drive storage devices, although they could alternatively be other devices, including arrays of disk drives configured to appear as a single large storage device to a host). The contents of the DASD 125, 126, and 127 may be loaded from and stored to the memory 102 as needed. The storage interface unit 112 may also support other types of devices, such as a tape device 131, an optical device, or any other type of storage device.

The I/O and other device interface 113 provides an interface to any of various other input/output devices or devices of other types. Two such devices, the printer 128 and the fax machine 129, are shown in the exemplary embodiment of FIG. 1, but in other embodiments, many other such devices may exist, which may be of differing types.

The network interface 114 provides one or more communications paths from the computer system 100 to other digital devices and computer systems, e.g., the client 132; such paths may include, e.g., one or more networks 130. In various embodiments, the network interface 114 may be implemented via a modem, a LAN (Local Area Network) card, a virtual LAN card, or any other appropriate network interface or combination of network interfaces.

Although the memory bus 103 is shown in FIG. 1 as a relatively simple, single bus structure providing a direct communication path among the processors 101, the main memory 102, and the I/O bus interface 105, in fact, the memory bus 103 may comprise multiple different buses or communication paths, which may be arranged in any of various forms, such as point-to-point links in hierarchical, star or web configurations, multiple hierarchical buses, parallel and redundant paths, etc. Furthermore, while the I/O bus interface 105 and the I/O bus 104 are shown as single respective units, the computer system 100 may, in fact, contain multiple I/O bus interface units 105 and/or multiple I/O buses 104. While multiple I/O interface units are shown, which separate the system I/O bus 104 from various communications paths running to the various I/O devices, in other embodiments, some or all of the I/O devices are connected directly to one or more system I/O buses.

The computer system 100, depicted in FIG. 1, has multiple attached terminals 121, 122, 123, and 124, such as might be typical of a multi-user “mainframe” computer system. Typically, in such a case the actual number of attached devices is greater than those shown in FIG. 1, although the present invention is not limited to systems of any particular size. The computer system 100 may alternatively be a single-user system, typically containing only a single user display and keyboard input, or might be a server or similar device which has little or no direct user interface, but receives requests from other computer systems (clients). In other embodiments, the computer system 100 may be implemented as a firewall, router, Internet Service Provider (ISP), personal computer, portable computer, laptop or notebook computer, PDA (Personal Digital Assistant), tablet computer, pocket computer, telephone, pager, automobile, teleconferencing system, appliance, or any other appropriate type of electronic device.

The network 130 may be any suitable network or combination of networks and may support any appropriate protocol suitable for communication of data and/or code to/from the computer system 100. In an embodiment, the network 130 may represent a storage device or a combination of storage devices, either connected directly or indirectly to the computer system 100. In an embodiment, the network 130 may support Infiniband. In another embodiment, the network 130 may support wireless communications. In another embodiment, the network 130 may support hard-wired communications, such as a telephone line, cable, or bus. In another embodiment, the network 130 may support the Ethernet IEEE (Institute of Electrical and Electronics Engineers) 802.3× specification.

In another embodiment, the network 130 may be the Internet and may support IP (Internet Protocol). In another embodiment, the network 130 may be a local area network (LAN) or a wide area network (WAN). In another embodiment, the network 130 may be a hotspot service provider network. In another embodiment, the network 130 may be an intranet. In another embodiment, the network 130 may be a GPRS (General Packet Radio Service) network. In another embodiment, the network 130 may be a FRS (Family Radio Service) network. In another embodiment, the network 130 may be any appropriate cellular data network or cell-based radio network technology. In another embodiment, the network 130 may be an IEEE 802.11B wireless network. In still another embodiment, the network 130 may be any suitable network or combination of networks. Although one network 130 is shown, in other embodiments any number of networks (of the same or different types) may be present.

The client 132 may further include some or all of the hardware components previously described above for the computer system 100. Although only one client 132 is illustrated, in other embodiments any number of clients may be present.

It should be understood that FIG. 1 is intended to depict the representative major components of the computer system 100, the network 130, and the clients 132 at a high level, that individual components may have greater complexity than represented in FIG. 1, that components other than, fewer than, or in addition to those shown in FIG. 1 may be present, and that the number, type, and configuration of such components may vary. Several particular examples of such additional complexity or additional variations are disclosed herein; it being understood that these are by way of example only and are not necessarily the only such variations.

The various software components illustrated in FIG. 1 and implementing various embodiments of the invention may be implemented in a number of manners, including using various computer software applications, routines, components, programs, objects, modules, data structures, etc., referred to hereinafter as “computer programs,” or simply “programs.” The computer programs typically comprise one or more instructions that are resident at various times in various memory and storage devices in the computer system 100, and that, when read and executed by one or more processors 101 in the computer system 100, cause the computer system 100 to perform the steps necessary to execute steps or elements embodying the various aspects of an embodiment of the invention.

Moreover, while embodiments of the invention have and hereinafter will be described in the context of fully functioning computer systems, the various embodiments of the invention are capable of being distributed as a program product in a variety of forms, and the invention applies equally regardless of the particular type of signal-bearing medium used to actually carry out the distribution. The programs defining the functions of this embodiment may be delivered to the computer system 100 via a variety of signal-bearing media, which include, but are not limited to:

(1) information permanently stored on a non-rewriteable storage medium, e.g., a read-only memory device attached to or within a computer system, such as a CD-ROM readable by a CD-ROM drive;

(2) alterable information stored on a rewriteable storage medium, e.g., a hard disk drive (e.g., DASD 125, 126, or 127), CD-RW, or diskette; or

(3) information conveyed to the computer system 100 by a communications medium, such as through a computer or a telephone network, e.g., the network 130, including wireless communications.

Such signal-bearing media, when carrying machine-readable instructions that direct the functions of the present invention, represent embodiments of the present invention.

In addition, various programs described hereinafter may be identified based upon the application for which they are implemented in a specific embodiment of the invention. But, any particular program nomenclature that follows is used merely for convenience, and thus embodiments of the invention should not be limited to use solely in any specific application identified and/or implied by such nomenclature.

The exemplary environments illustrated in FIG. 1 are not intended to limit the present invention. Indeed, other alternative hardware and/or software environments may be used without departing from the scope of the invention.

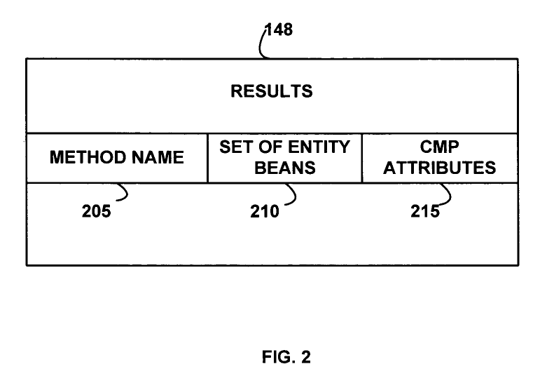

FIG. 2 depicts a block diagram of an example data structure for the results 148, according to an embodiment of the invention. The results 148 includes a method name 205, a set of entity beans 210, and CMP (container managed persistence) attributes 215. Although the set of entity beans 210 is illustrated, in another embodiment any appropriate set of persistent objects may be used. The method name 205 identifies a method in the application 150 that may initiate one or more transactions. The execution of each transaction initiated within the method may result in the execution of a statement or statements that create or remove the entity beans in the set of entity beans 210 or may result in the execution of a statement or statements that read or update container managed fields with the CMP attributes 215. Examples of the CMP attributes 215 include create, remove, read, and update, but in other embodiments any appropriate attributes may be used. Although only one method name 205, set of entity beans 210, and CMP attributes 215 are illustrated, in other embodiments any number of them with any appropriate data may be present.

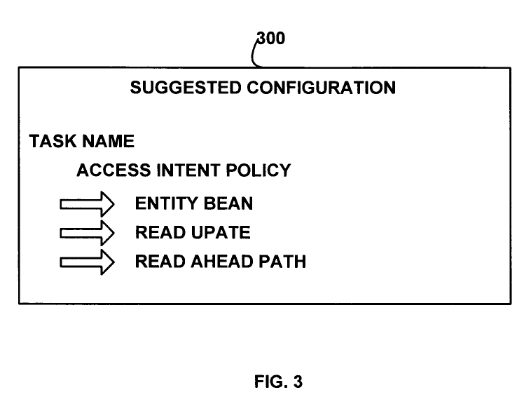

FIG. 3 depicts a block diagram of an example user interface 300 for displaying a suggested configuration for optional modification by a user, according to an embodiment of the invention. The example user interface 300 includes the access intent policies in a task name. A task names all unit of work instances that are initiated at a particular point in the application 150. So, for example, all transactions that begin on the method bean. X( ) could be given the task name bean_X. Examples of the suggested configuration include access intent policies, such as entity bean, read update, and read ahead path. The user may use the user interface 300 to modify the suggested configuration. The configuration manager 156 creates the suggested configuration based on the results 148 and the application 150. The suggested configuration illustrated in FIG. 3 is exemplary only and in other embodiments any appropriate suggested configuration may be used.

FIG. 4 depicts a flowchart of example logic at the analysis engine 154 and the configuration manager 156, according to an embodiment of the invention. Control begins at block 400. Control then continues to block 405 where the configuration manager 156 passes the deployment descriptors 152 and application classes and class files of the application 150 to the analysis engine 154. Control then continues to block 410 where the analysis engine 154 builds a call graph based on the class files and the application classes. Control then continues to block 415 where the analysis engine 154 performs a program analysis of the application 150 to determine potential boundaries of scoped units of work relevant for configuration tasks. In an embodiment, each scoped unit of work corresponds to a transaction in the EJB programming model, but in other embodiments other programming models may be used The analysis engine 154 may solve a data flow problem based on the deployment descriptors 152 and the call graph in order to identify the boundaries of scoped units of work.

Control then continues to block 420 where the analysis engine 154 traverses the call graph identifying statements that create or remove persistent objects, such as entity beans, and statements that read or update container managed fields in the scope of each unit of work. For each of the identified statements, the analysis engine 154 saves the associated method name 205, the associated set of entity beans 210 and the associated container managed persistence attributes 215 in the results 148. Control then continues to block 425 where the analysis engine 154 sends the results 148 to the configuration manager 156.

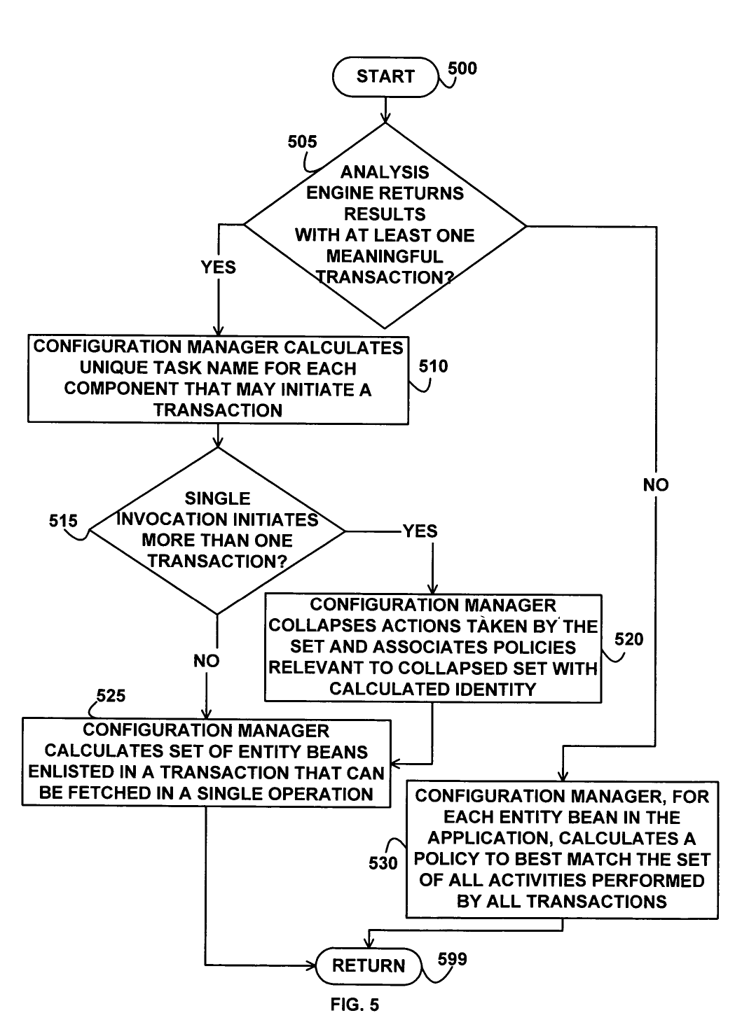

Control then continues to block 430 where the configuration manager 156 creates a suggested configuration based on the results 148 (as further described below with reference to FIG. 5) and a visual representation of the suggested configuration (as previously described above with reference to FIG. 3). Control then continues to block 435 where the user accepts or modifies the suggested configuration, as previously described above with reference to FIG. 3.

Control then continues to block 440 where the configuration manager 156 creates encoding of transaction configurations into the deployment descriptor 152 based on the suggested configuration as optionally modified by the user. Control then continues to block 445 where the runtime system 146 uses the encoding in the deployment descriptor 152 to optimize the transactions performed by the application 150. Control then continues to block 499 where logic of 499 returns.

FIG. 5 depicts a flowchart of example processing for creating a suggested configuration, according to an embodiment of the invention. Control begins at block 500. Control then continues to block 505 where the configuration manager 156 determines whether the analysis engine 154 returns results that contain at least one identified transaction that potentially enlists at least one entity bean or other persistent object, which makes the identified transaction a meaningful transaction. If the determination at block 505 is true, then control continues to block 510 where the configuration manager 156 calculates a unique task name for each component that may initiate a transaction. In various embodiments, the component may be a J2EE component, a J2EE application client, a servlet, a jsp, an enterprise java bean method, or any other appropriate type of component or method. The transactions are initiated by the statements in the application 150 that create or remove persistent objects (e.g., entity beans) or statements that read or update container managed fields in scope of each unit of work, as previously identified at block 420 and stored in the method name 205, the set of entity beans 210, and the CMP attributes 215, as previously described above.

Control then continues to block 515 where the configuration manager 156 determines whether a single invocation of the component may initiate more than one transaction. If the determination at block 515 is true, then control continues to block 520 where the configuration manager 156 collapses actions taken by the set of transactions initiated by the component and associates the policies relevant to the collapsed set of actions with the calculated unique task name.

Control then continues to block 525 where the configuration manager 156 calculates from the results 148 a set of persistent objects, such as entity beans, potentially enlisted in the transaction that can be fetched in a single operation from a backend store according to the abilities to the targeted application server. Control then continues to block 599 where the logic of FIG. 5 returns.

If the determination at block 515 is false, then control continues to block 525, as previously described above.

If the determination at block 505 is false, then control continues to block 530 where the configuration manager 156, for each persistent object, such as an entity bean, in the application 150, calculates a policy to best match the set of all activities performed by all transactions that operate in the application 150. Control then continues to block 599 where the logic of FIG. 5 returns.

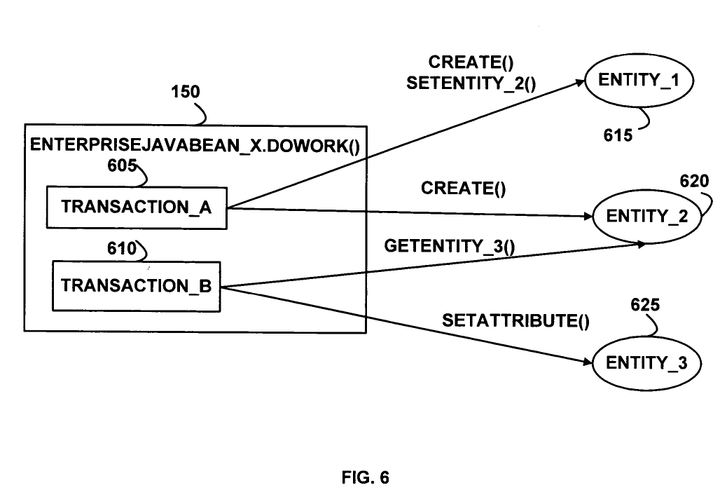

FIG. 6 depicts a block diagram illustrating analysis of the application 150, according to an embodiment of the invention. For this example, during the execution of the do Work( ) method of EnterpriseJavaBean_X, the analysis engine 154 reports two possible transactions: a transaction_a 605 and a transaction_b 610. In the transaction_a 605, instances of Entity_1 615 and Entity_2 620 may be created, and Entity_2's relationship may be established to Entity_1 615 by a call to setEntity_2( ). In the transaction_b 610, an instance of Entity_3 625 may be retrieved from Entity_2 620 by a call to Entity_2's getEntity3( ) method, and Entity_3's attribute may be set by the call to setAttribute ( ).

The configuration manager 156 creates a unique task name that is associated with the execution of transactions that begin within the do Work( ) method. The configuration manager 156 creates a set of policies that are best suited for the operations that may be performed on the set of transactions that will execute during do Work( ). In this example, the execution of setEntity_2( ) during the transaction_a 605 indicates that when the data for Entity_2 620 is fetched from the backend store, a lock is acquired when operating pessimistically. The call to getEntity_3( ) on Entity_2 620 during transaction_b 610 indicates that the data for Entity_3 625 is prefetched at the same time that the data for Entity_2 620 is fetched from the backend store. The call to setAttribute( ) indicates that Entity_3 625 should hold update locks; because Entity_3 625 and Entity_2 620 will be loaded in a single access to the backend store, the configuration manager 156 determines that Entity_2 620 should be configured to load with update locks in order to be consistent with the configuration of Entity_3 625.

In the previous detailed description of exemplary embodiments of the invention, reference was made to the accompanying drawings (where like numbers represent like elements), which form a part hereof, and in which is shown by way of illustration specific. exemplary embodiments in which the invention may be practiced. These embodiments were described in sufficient detail to enable those skilled in the art to practice the invention, but other embodiments may be utilized, and logical, mechanical, electrical, and other changes may be made without departing from the scope of the present invention. Different instances of the word “embodiment” as used within this specification do not necessarily refer to the same embodiment, but they may. The previous detailed description is, therefore, not to be taken in a limiting sense, and the scope of the present invention is defined only by the appended claims.

In the previous description, numerous specific details were set forth to provide a thorough understanding of the invention. But, the invention may be practiced without these specific details. In other instances, well-known circuits, structures, and techniques have not been shown in detail in order not to obscure the invention.

What is claimed is:

1. A method comprising:
identifying a component in an application, wherein the component initiates a transaction;
calculating a set of persistent objects potentially enlisted by the transaction;
calculating a set of potential operations that the transaction may perform with respect to each of the potentially enlisted persistent objects; and
optimizing the transaction based on a configuration, wherein the configuration is based on the set of potential operations that the transaction may perform with respect to each of the potentially enlisted persistent objects.

2. The method of claim 1, further comprising:
determining whether a single invocation of the component initiates more than one transaction.

3. The method of claim 2, further comprising:
if the determining is true, collapsing actions taken by the set of potential operations into a collapsed set.

4. The method of claim 1, further comprising:
calculating a unique task name for the component.

5. The method of claim 3, further comprising:
if the determining is true, associating policies relevant to the collapsed set with a unique task name for the component.

6. An apparatus comprising:
means for identifying a component in an application, wherein the component initiates a transaction;
means for calculating a set of persistent objects potentially enlisted by the transaction, wherein the set of persistent objects can be fetched in a single operation;
means for calculating a set of potential operations that the transaction may perform with respect to each of the potentially enlisted persistent objects; and
means for optimizing the transaction based on a configuration, wherein the configuration is based on the set of potential operations that the transaction may perform with respect to each of the potentially enlisted persistent objects.

7. The apparatus of claim 6, wherein the transaction is initiated by a statement in the application that creates at least one of the set of persistent objects.

8. The apparatus of claim 6, wherein the transaction is initiated by a statement in the application that removes at least one of the set of persistent objects.

9. The apparatus of claim 6, wherein the transaction is initiated by a statement in the application that reads at least one container managed field with container managed persistence attributes.

10. The apparatus of claim 6, wherein the transaction is initiated by a statement in the application that updates at least one container managed field with container managed persistence attributes.

11. A signal-bearing medium encoded with instructions, wherein the instructions when executed comprise:
identifying a component in an application, wherein the component initiates a transaction;
calculating a set of persistent objects potentially enlisted by the transaction, wherein the set of persistent objects can be fetched in a single operation;
calculating a set of potential operations that the transaction may perform with respect to each of the potentially enlisted persistent objects, wherein the potential operations are selected from a group consisting of create, read, update, and delete; and
optimizing the transaction based on a configuration, wherein the configuration is based on the set of potential operations that the transaction may perform with respect to each of the potentially enlisted persistent objects.

12. The signal-bearing medium of claim 11, wherein the identifying further comprises:
building a call graph based on classes of the application.

13. The signal-bearing medium of claim 12, wherein the identifying further comprises:
traversing the call graph.

14. A computer system comprising:
a processor; and
memory encoded with instructions, wherein the instructions when executed on the processor comprise:
identifying a component in an application, wherein the component initiates a transaction,
calculating a set of persistent objects potentially enlisted by the transaction, wherein the set of persistent objects can be fetched in a single operation,
calculating a set of potential operations that the transaction may perform with respect to each of the potentially enlisted persistent objects, wherein the potential operations are selected from a group consisting of create, read, update, and delete,
determining whether a single invocation of the component initiates more than one transaction,
if the determining is true, collapsing actions taken by the set of potential operations into a collapsed set, and
optimizing the transaction based on a configuration, wherein the configuration is based on the set of potential operations that the transaction may perform with respect to each of the potentially enlisted persistent objects.

15. The computer system of claim 14, wherein the optimizing further comprises:
creating an encoding of the configuration into a deployment descriptor.

16. The computer system of claim 15, wherein the optimizing further comprises:
optimizing the transaction based on the encoding.

17. The computer system of claim 14, wherein the instructions further comprise:
providing an interface for a user to modify the configuration.

18. A method for configuring a computer, comprising:
configuring the computer to identify a component in an application, wherein the component initiates a transaction;
configuring the computer to calculate a set of persistent objects potentially enlisted by the transaction;
configuring the computer to calculate a set of potential operations that the transaction may perform with respect to each of the potentially enlisted persistent objects; and
configuring the computer to optimize the transaction based on a configuration, wherein the configuration is based on the set of potential operations that the transaction may perform with respect to each of the potentially enlisted persistent objects.

19. The method of claim 18, further comprising:
if a single invocation of the component initiates more than one transaction, collapsing actions taken by the set into a collapsed set.

20. The method of claim 19, further comprising:
if the single invocation of the component initiates more than one transaction, associating policies relevant to the collapsed set with the unique task name.
